(19) United States
(12) Patent Application Publication
(10) Pub. No.: US 2013/0254679 A1
(43) Pub. Date: Sep. 26, 2013

(54) APPARATUS AND METHOD FOR CREATING E-MAIL IN A PORTABLE TERMINAL

(71) Applicant: SAMSUNG ELECTRONICS CO., LTD., Gyeonggi-do (KR)

(72) Inventors: Kyung-Hwan KIM, Gyeonggi-do (KR); Yong-Seok KIM, Gyeonggi-do (KR); Hyun-Jung KIM, Gyeonggi-do (KR); Ju-Seung LEE, Gyeonggi-do (KR)

(73) Assignee: SAMSUNG ELECTRONICS CO., LTD., Gyeonggi-do (KR)

(21) Appl. No.: 13/827,292

(22) Filed: Mar. 14, 2013

(30) Foreign Application Priority Data
Mar. 20, 2012 (KR) 10-2012-0028435

(51) Int. Cl. G06F 3/048

(52) U.S. Cl. CPC G06F 3/048
USPC 715/752

(57) ABSTRACT

Provided is an apparatus and method for creating an e-mail in a portable terminal, in which the e-mail can be created using a template. The apparatus includes a display unit comprising an input region and a display region and a controller for searching for and displaying a template corresponding to a search gesture generated on the display unit during an e-mail creation mode. The apparatus may also include a memory for storing templates and a controller for storing a new template comprising only a text selected in a template displayed in an e-mail mode.

### CLAIM OF PRIORITY

This application claims the benefit under 35 U.S.C. §119(a) of a Korean Patent Application filed in the Korean Intellectual Property Office on Mar. 20, 2012 and assigned Serial No. 10-2012-0028435, the entire disclosure of which is hereby incorporated by reference.

### BACKGROUND OF THE INVENTION

1. Field of the Invention

The present invention generally relates to an apparatus and method for creating an e-mail in a portable terminal using a template.

2. Description of the Related Art

Generally, when a user uses an e-mail in a Personal Computer (PC) environment, if the mail has to be created in a particular format, a specific template is retrieved for a display according to the selection made by the user.

In a general PC environment, a search window and a number of lists for item selection are all provided on a single screen during a search mode, whereas in a smart phone environment, the user has to undergo several steps, such as a menu step, to enter a search mode, and then further perform the screen manipulation for further selection. Also, a displayed screen size is limited, such that the number of lists which can be displayed on a single screen is limited. This situation is equally applied to when a search result is shown on a search window, and thus the search interface in the general PC environment for templates is not suitable for use in the smart phone environment.

Moreover, when the user uses a function of directly editing and storing a provided template, the user is conveniently provided with a keyboard and a mouse when editing a text in the general PC environment, but this convenience is not available in the smart phone environment.

### SUMMARY OF THE INVENTION

Accordingly, the present invention provides an apparatus and method for creating an e-mail in a portable terminal, by which the e-mail can be created using a template.

According to an aspect of the present invention, an apparatus for creating an e-mail in a portable terminal includes a display unit comprising an input region and a display region, and a controller for retrieving a template corresponding to a search gesture generated on the display unit for a display during an e-mail creation mode.

According to another aspect of the present invention, an apparatus for creating an e-mail in a portable terminal includes a memory for storing templates, and a controller for storing a new template comprising only a text selected in a template displayed during an e-mail mode.

According to another aspect of the present invention, a method for creating an e-mail in a portable terminal includes determining whether a search gesture is generated on a display unit during an e-mail creation mode and, if so, retrieving a template corresponding to the generated search gesture for a display.

According to another aspect of the present invention, a method for creating an e-mail in a portable terminal includes displaying a template in an e-mail mode and storing a new template comprising only a text selected in the displayed template.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is a block diagram of a portable terminal according to an embodiment of the present invention;

FIG. 2 is a flowchart of a process of displaying a template in an e-mail creation mode of a portable terminal according to a first embodiment of the present invention;

FIG. 3 is a flowchart of a process of displaying a template in an e-mail creation mode of a portable terminal according to a second embodiment of the present invention;

FIG. 4 is a flowchart of a process of displaying a template in an e-mail creation mode of a portable terminal according to a third embodiment of the present invention;

FIG. 5 is a flowchart of a process of displaying a template in an e-mail creation mode of a portable terminal according to a fourth embodiment of the present invention;

FIG. 6 is a flowchart of a process of displaying a template in an e-mail creation mode of a portable terminal according to a fifth embodiment of the present invention;

FIG. 7 is a flowchart of a process of editing a template in an e-mail creation mode of a portable terminal according to another embodiment of the present invention;

FIG. 8 is a flowchart of a process of editing a template in an e-mail creation mode of a portable terminal according to yet another embodiment of the present invention;

FIG. 9 is a flowchart of a process of editing a template in an e-mail creation mode of a portable terminal according to yet another embodiment of the present invention;

FIG. 10 is a flowchart of a process of editing a template in an e-mail creation mode of a portable terminal according to yet another embodiment of the present invention;

FIGS. 11A and 11B are diagrams for describing displaying of a template in an e-mail creation mode of a portable terminal according to an embodiment of the present invention; and

FIGS. 12A and 12B are diagrams for describing editing of a template in an e-mail creation mode of a portable terminal according to an embodiment of the present invention.

### DETAILED DESCRIPTION OF THE EXEMPLARY EMBODIMENTS

Hereinafter, exemplary embodiments of the present invention will be described in detail with reference to the accompanying drawings. It should be noted that throughout the drawings, like components are referred to as like reference numerals.

In the present invention, a template refers to a document format, for example, an agreement, a resume, a cover letter, attendance/absence, or the like.

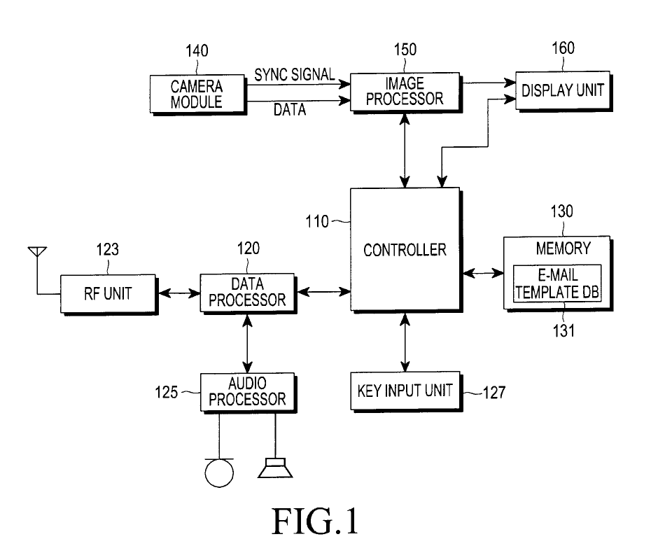

FIG. 1 is a block diagram of a portable terminal according to an embodiment of the present invention.

Referring to FIG. 1, a Radio Frequency (RF) unit 123 performs a radio communication function of the portable terminal. The RF unit 123 includes an RF transmitter for up-converting a frequency of a transmission signal and amplifying the transmitted signal and an RF receiver for low-noise amplifying a received signal and down-converting the frequency of the received signal. A data processor 120 includes a transmitter for encoding and modulating the transmission signal and a receiver for demodulating and decoding the received signal. That is, the data processor 120 may include a modem and a codec. Herein, the codec includes a data codec for processing packet data and an audio codec for processing an audio signal such as voice. An audio processor 125 reproduces a received audio signal being output from the audio codec of the data processor 120 or transmits a transmission audio signal generated from a microphone to the audio codec of the data processor 120.

A key input unit 127 includes keys for inputting numeric and character information and functional keys for setting various functions.

A memory 130 includes program and data memories. The program memory stores programs for controlling a general operation of the portable terminal and programs for displaying a template through a search gesture in an e-mail creation mode and editing a template in an e-mail mode according to an embodiment of the present invention. The data memory also temporarily stores data generated during execution of the programs.

The memory 130 stores various types of templates in an e-mail template database (DB) 131 according to an embodiment of the present invention.

A controller 110 functions to control the overall operation of the portable terminal.

According to an embodiment of the present invention, the controller 110 searches for and displays a template corresponding to a search gesture generated on a display unit (160) during the e-mail creation mode. To this end, upon generation of the search gesture including a touch on a predetermined key in an input region 162 of the display unit and a subsequent drag to a display region 161 during the e-mail creation mode, the controller 110 searches for and displays templates whose titles include a character corresponding to the selected predetermined key. In this case, the controller 110 retrieves and displays templates whose titles include a character disposed on the predetermined key as a first character thereof.

Alternatively, if the search gesture including a touch on a predetermined key in the input region 162 of the display unit and a subsequent drag to the display region 161 is generated at least two times within a predetermined time during the e-mail creation mode, the controller 110 searches for and displays templates whose titles sequentially include characters disposed on at least two keys which are touched sequentially.

According to another embodiment of the present invention, upon generation of the search gesture including a touch on a predetermined key in the input region 162 of the display unit and a subsequent drag to the display region 161 during the e-mail creation mode, the controller 110 searches for and displays templates whose titles include a character disposed on the predetermined key. During a display of the found templates, upon generation of a search gesture including a touch on another key in the input region 162 of the display unit and a subsequent drag to the display region 161, the controller 110 retrieves and displays a template whose title includes the character displayed on another key among the templates displayed on the display region 161. In this case, the controller 110 searches for templates whose titles include the character displayed on the predetermined key as a first character and then searches among the found templates for a template whose title includes the character displayed on another key as a second character.

Alternatively, upon generation of the search gesture including touches on at least two keys in the input region (162) of the display unit and a subsequent drag to the display region (161) in the e-mail creation mode, the controller 110 searches for and displays templates whose titles sequentially include characters corresponding to the at least two keys that are sequentially touched.

While a template is searched by inputting a character in the input region of the display unit and then generating a drag to the display region of the display unit during the e-mail creation mode according to an embodiment of the present invention, a template may also be searched by inputting a character through the key input unit and then generating a drag in a predetermined direction in the display unit which in turn displays only the display region without the input region or by generating a drag to the display region from the input region.

According to yet another embodiment of the present invention, when at least one characters are input together with a special character in the input region 162 of the display unit (160) and thus are displayed in the display region 161 of the display unit (160) during the e-mail creation mode, the controller 110 searches for and displays templates whose titles include the at least one characters input together with the special character. The controller 110 searches for and displays templates whose titles sequentially include the at least one characters input together with the special character.

According to another embodiment of the present invention, the controller 110 stores a template including only a text selected from the template displayed in the e-mail mode as a new template.

According to another embodiment of the present invention, the controller 110 converts the e-mail mode into a template editing mode if edition is selected during displaying of the template during the e-mail mode, and stores a template including only a text selected from a text of the template in the template editing mode by a dragging operation as a new template. In this case, the controller 110 selects the text for which the dragging operation is performed in word units or in word spacing units.

According to yet another embodiment of the present invention, the controller 110 converts the e-mail mode into the template editing mode if edition is selected during displaying of the template during the e-mail mode, and if the entire text of the template is selected and then selection of at least one words is released in the template editing mode, then the controller 110 stores only a text excluding the selection-released words as a new template. In this case, the controller 110 selects the entire text of the template in word units or word spacing units, and upon generation of touches on at least one words of the selected text, the controller 110 releases selection of the at least one words or a phrase including the at least one words.

Alternatively, the controller 110 converts the e-mail mode into the template editing mode if edition is selected during displaying of the template in the e-mail mode, displays font types used in the template in the template editing mode, and stores only a text using a selected font as a new template.

Alternatively, the controller 110 converts the e-mail mode into the template editing mode if edition is selected during displaying of the template in the e-mail mode, displays font types used in the template in the template editing mode, and stores only the remaining text excluding the text using the selected font as a new template.

A camera module 140 captures an image, and may include a camera sensor for converting an optical signal of the captured image into an electrical signal, and a signal processor for converting an analog image signal of the image captured by the camera sensor into digital data. Herein, it is assumed that the camera sensor is a Charge Coupled Device (CCD) sensor or a Complementary Metal Oxide Semiconductor (CMOS) sensor, and the signal processor may be implemented as a Digital Signal Processor (DSP). In addition, the camera sensor and the signal processor may be implemented as one piece or separately.

The image processor 150 performs Image Signal Processing (ISP) to display an image signal output from the camera module 140 on a display unit 160. The ISP executes functions such as gamma correction, interpolation, color space conversion, image effect, image scale, Auto White Balance (AWB), Auto Exposure (AE) and Auto Focus (AF). Thus, the image processor 150 processes the image signal output from the camera module 140 in the unit of a frame, and outputs frame image data adaptively to the features and size of the display unit 160. The image processor 150 includes an image codec, and compresses the frame image data displayed on the display unit 160 in a preset manner or restores the compressed frame image data to the original frame image data. Herein, the image codec may be Joint Picture Experts Group (JPEG) codec, Moving Picture Experts Group 4 (MPEG4) codec, or Wavelet codec. It is assumed that the image processor 150 has an on screen display (OSD) function. The image processor 150 may output OSD data according to the displayed picture size under the control of the controller 110.

The display unit 160 displays an image signal output from the image processor 150 on the screen and displays user data output from the controller 110. Herein, the display unit 160 may be a Liquid Crystal Display (LCD), and in this case, the display unit 160 may include an LCD controller, a memory capable of storing image data, an LCD element, and so on. When the LCD is implemented with a touch screen, it may also serve as an input unit, and in this case, keys such as the key input unit 127 may be displayed on the display unit 160.

The display unit 160 may include the display region 161 and the input region 162, and the input region 162 of the display unit 160 may display the keys of the key input unit (127) which includes keys for inputting numeric and character information and function keys for setting various functions.

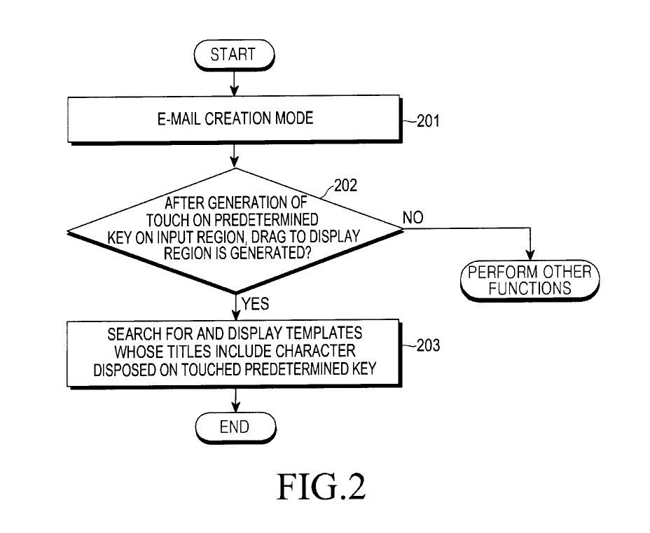

With reference to FIGS. 2 through 11, a detailed description will be made regarding an operation of creating an e-mail using a template according to the teachings of the present invention.

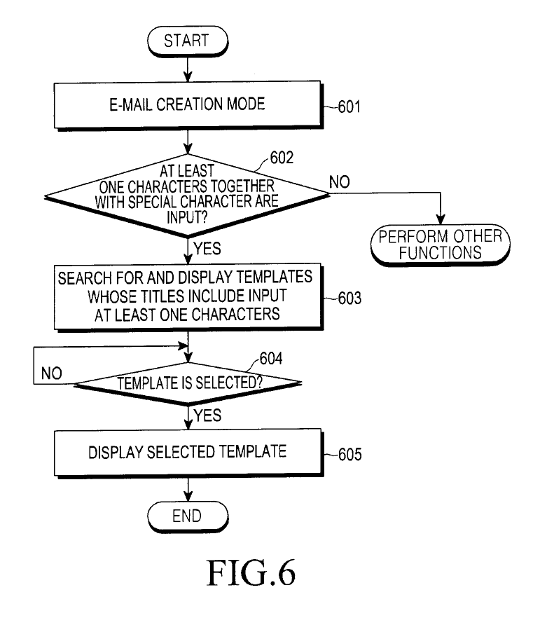

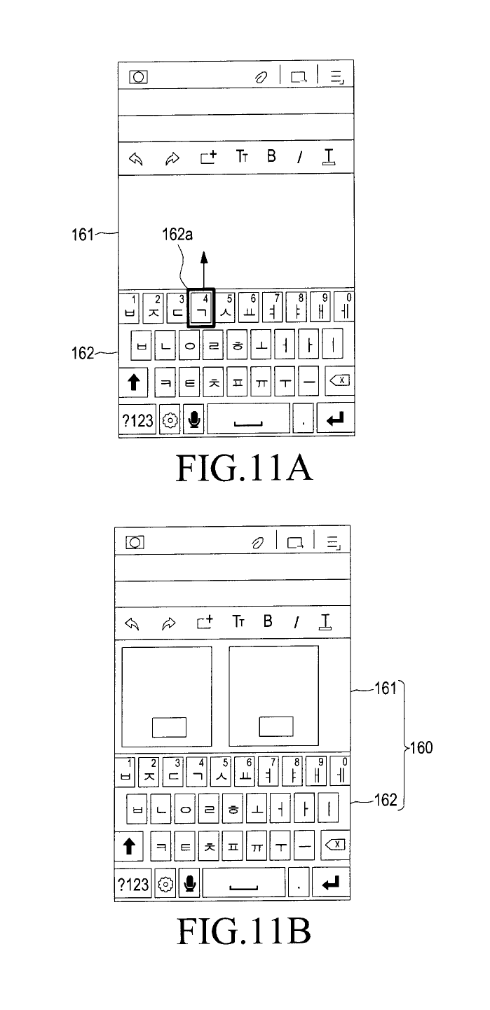

First, an operation of displaying a template in the portable terminal will be described in detail with reference to FIGS. 6 and 11A and 11B.

FIG. 2 is a flowchart of a process of displaying a template during the e-mail creation mode of the portable terminal according to a first embodiment of the present invention, and FIGS. 11A and 11B are diagrams for describing displaying of a template during the e-mail creation mode of the portable terminal according to an embodiment of the present invention.

Hereinafter, the first embodiment of the present invention will be described also with reference to FIGS. 1 and 2.

Referring to FIG. 2, upon selection of an e-mail creation request during the e-mail mode of the portable terminal, the controller 110 senses the selection and switches to the e-mail creation mode in step 201.

In the e-mail creation mode, the display unit 160 is displayed showing the display region 161 and the input unit 162; the display region 161 displays e-mail related contents according to an input on the input region 162; and the input region 162 displays a plurality of keys for receiving a touch input thereon.

Upon generation of a drag motion to the display region 161 after the generation of a touch on a predetermined one of the plurality of keys displayed on the input region 162, the controller 110 senses the drag motion in step 202 and searches in the e-mail template DB 131 of the memory 130 for templates whose titles include a character corresponding to the touched predetermined key and then displays the found templates on the display region 161 in step 203.

In step 203, according to settings, the controller 110 may search for and display templates whose titles include the character corresponding to the touched predetermined key as its first character.

Referring to FIGS. 11A and 11B, which shows a working example of the process shown in FIG. 2, upon generation of a drag motion to the display region 161 after the generation of a touch on a predetermined key 162a among the plurality of keys displayed on the input region 162 during the e-mail creation mode, then the controller 110 searches in the e-mail template DB 131 for templates including a character “ [symbol] ” corresponding to the activated predetermined key 162a as a first character in titles thereof, e.g., “ [symbol] (contract)”, “ [symbol] 1(attendance/absence 1)”, “ [symbol] 2(attendance/absence 2)”, and “ [symbol] 3(attendance/absence 3)”. Then, the templates found in the e-mail template DB 131 are displayed sequentially as image screens on the display unit 161 as shown in FIG. 11B.

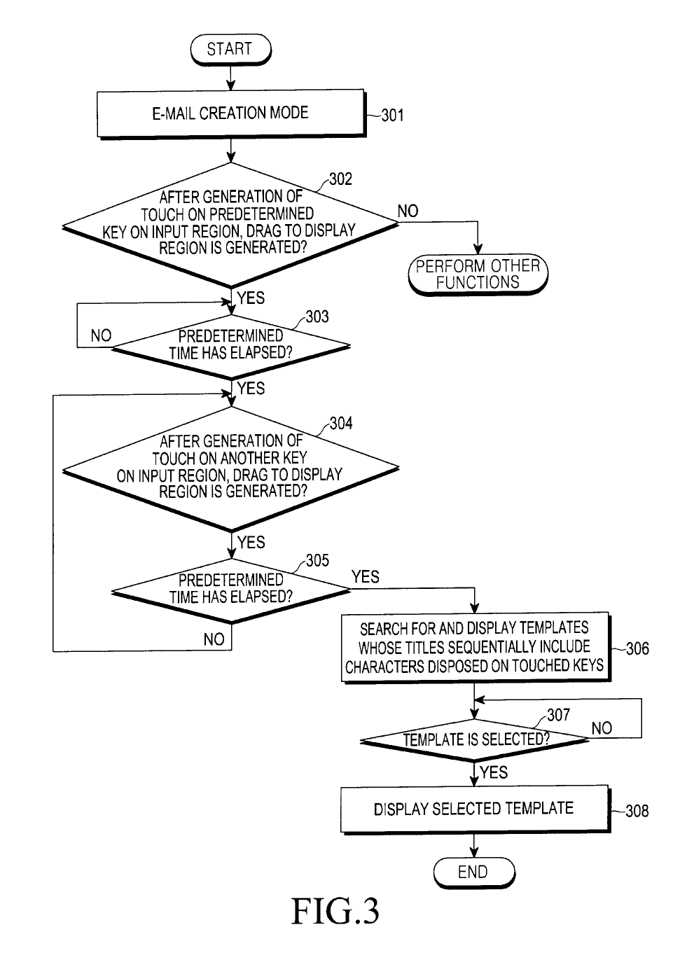

FIG. 3 is a flowchart of a process of displaying a template during the e-mail creation mode of the portable terminal according to a second embodiment of the present invention.

Referring to FIGS. 1 and 3, upon selection of e-mail creation during the e-mail mode of the portable terminal, the controller 110 senses the selection and switches to the e-mail creation mode in step 301.

In the e-mail creation mode, the display unit 160 is displayed showing the display region 161 and the input unit 162; the display region 161 displays e-mail related contents according to an input on the input region 162; and the input region 162 displays the plurality of keys for receiving a touch input thereon.

Upon generation of a drag motion to the display region 161 after the generation of a touch on a predetermined key among the plurality of keys displayed on the input region 162 during the e-mail creation mode, the controller 110 senses the generation in step 302 and determines whether a drag to the display region 161 is generated after the generation of a touch on another key among the plurality of keys displayed on the input region 162 prior to the elapse of a predetermined time in step 305.

Upon generation of another drag to the display region 161 after the generation of a touch on another key among the plurality of keys displayed on the input region 162 prior to the elapse of the predetermined time, then the controller 110 senses the generation in steps 303 and 304, and then determines again whether another drag to the display region 161 is detected.

During repetition processes of steps 303 through 305, unless the a drag to the display region 161 is generated, the controller 110 senses the non-generation in step 305, and then searches in the e-mail template DB 131 of the memory 130 for templates whose titles sequentially include characters corresponding to at least two keys which are sequentially touched on the input region 162 during steps 303 through 305 and displays the found templates on the display region 161 in step 306.

Accordingly, at least two templates having matched characters are displayed on the display region 161 as images, and upon user's selection of one of them, the controller 110 senses the selection in step 307 and displays only the selected template in step 308.

Note that the keys touched on the input region 162 in steps 302 and 304 may be identical or different keys.

For example, if a drag to the display region 161 is generated after the generation of a touch on a predetermined key on which the character “ [symbol] ” is disposed among the plurality of keys displayed on the input region 162, and if a touch on another key on which a character “ [symbol] ” is disposed among the plurality of keys displayed on the input region 162 is generated prior to the elapse of the predetermined time, and then a drag to the display region 161 is generated and sensed, then the controller 110 searches in the e-mail template DB 131 of the memory 130 for templates whose titles sequentially include the character “ [symbol] ” and the character “ [symbol] ”, e.g., the templates “ [symbol] 1(attendance/absence 1)”, “ [symbol] 2(attendance/absence 2)”, and “ [symbol] 3(attendance/absence 3)”. The controller 110 may also display the templates “ [symbol] 1(attendance/absence 1)”, “ [symbol] 2(attendance/absence 2)”, and “ [symbol] 3(attendance/absence 3)” found in the e-mail template DB 131 as images on the display region 161.

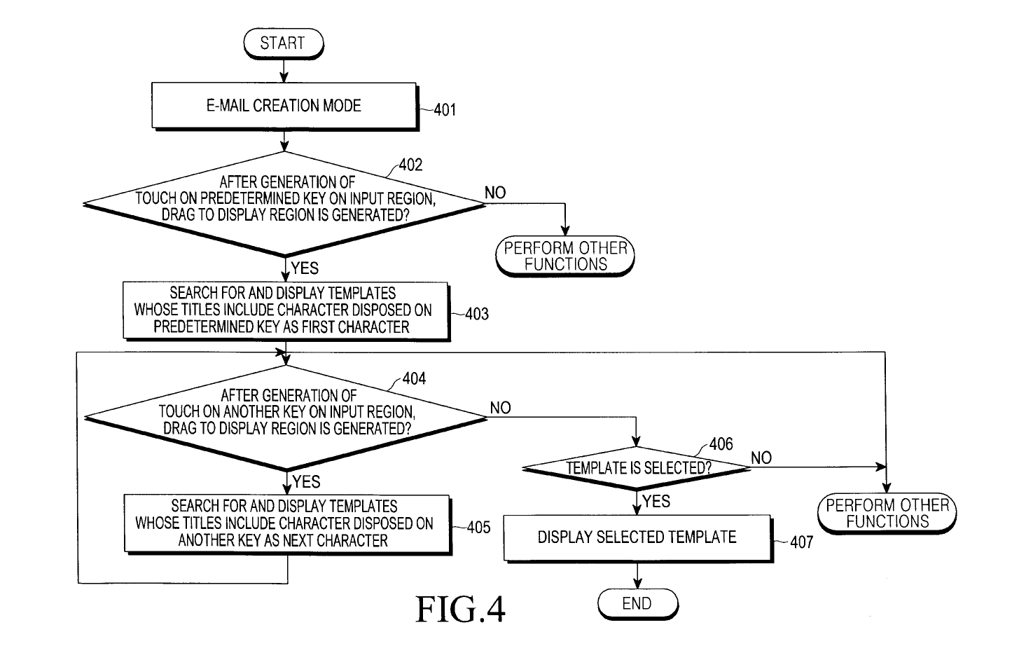

FIG. 4 is a flowchart of a process of displaying a template during the e-mail creation mode of the portable terminal according to a third embodiment of the present invention.

Referring to FIGS. 1 and 4, upon selection of e-mail creation during the e-mail mode of the portable terminal, the controller 110 senses the selection and switches to the e-mail creation mode in step 401.

In the e-mail creation mode, the display unit 160 is displayed showing the display region 161 and the input unit 162; the display region 161 displays e-mail related contents according to an input on the input region 162; and the input region 162 displays the plurality of keys for a touch input.

Upon generation of a drag to the display region 161 after the generation of a touch on a predetermined key among the plurality of keys displayed on the input region 162 during the e-mail creation mode, the controller 110 senses the generation in step 402 and searches in the e-mail template DB 131 of the memory 130 for templates whose titles include a character corresponding to the touched predetermined key and displays the found templates on the display region 161 in step 403.

In step 403, according to settings, the controller 110 may search for and display templates whose titles include the character corresponding to the touched predetermined key as its first character.

If a drag to the display region 161 is generated after the generation of a touch on another key among the plurality of keys displayed on the input region 162 during displaying of the templates whose titles include the character disposed on the touched predetermined key in step 403, then the controller 110 senses the generation in step 404, and searches in the e-mail template DB 131 of the memory 130 for a template whose title includes a character disposed on another key touched in step 404 among the displayed templates and displays the found template in step 405.

In step 405, according to settings, the controller 110 may search for and display a template whose title includes the character disposed on the touched another key as the next character among the displayed templates.

When the templates found during repetition of steps 404 and 405 are displayed, if one template is selected by the user, the controller 110 senses the selection in step 406 and displays only the selected template in step 407.

The keys touched on the input region 162 in steps 402 and 404 may be identical or different keys. For example, upon generation of a drag to the display region 161 after the generation of a touch on the predetermined key on which the character “ [symbol] ” is disposed among the plurality of keys displayed on the input region 162 in the e-mail creation mode, the controller 110 senses the generation, and searches in the e-mail template DB 131 of the memory 130 for templates whose titles include the character “ [symbol] ” as its first character, e.g., the templates “ [symbol] (contract)”, “ [symbol] 1(attendance/absence 1)”, “ [symbol] 2(attendance/absence 2)”, and “ [symbol] 3(attendance/absence 3)”, and displays the found templates as images on the display region 161. Upon generation of a drag to the display region 161 after generation of a touch on a predetermined key on which the character “ [symbol] ” is disposed among the plurality of keys displayed on the input region 162, then the controller 110 senses the generation, and searches in the e-mail template DB 131 of the memory 130 for the templates whose titles include the character “ [symbol] ” as the next character, i.e., the second character, such as the templates “ [symbol] 1(attendance/absence 1)”, “ [symbol] 2(attendance/absence 2)”, and “ [symbol] 3(attendance/absence 3)”, among the displayed templates “ [symbol] (contract)”, “ [symbol] 1(attendance/absence 1)”, “ [symbol] 2(attendance/absence 2)”, and “ [symbol] 3(attendance/absence 3)”, and displays the found templates as images on the display region 161.

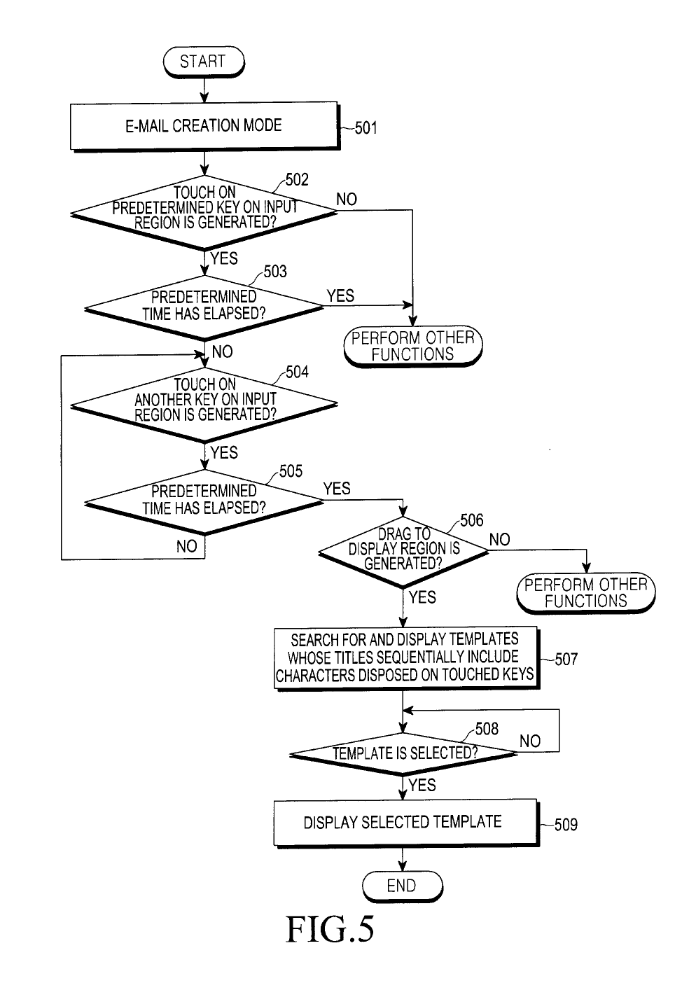

FIG. 5 is a flowchart of a process of displaying a template during the e-mail creation mode of the portable terminal according to a fourth embodiment of the present invention.

Referring to FIGS. 1 and 5, upon selection of e-mail creation during the e-mail mode of the portable terminal, the controller 110 senses the selection and switches to the e-mail creation mode in step 501.

In the e-mail creation mode, the display unit 160 is displayed showing the display region 161 and the input unit 162; the display region 161 displays e-mail related contents according to an input on the input region 162; and the input region 162 displays the plurality of keys for a touch input.

Upon generation of a drag to the display region 161 after the generation of a touch on a predetermined key among the plurality of keys displayed on the input region 162 during the e-mail creation mode, the controller 110 senses the generation in step 502 and determines whether a touch on another key among the plurality of keys displayed on the input region 162 is generated prior to the elapse of a predetermined time in step 502.

Upon generation of a touch on another key among the plurality of keys displayed on the input region 162 prior to the elapse of the predetermined time, then the controller 110 senses the generation in steps 503 and 504, and determines again whether a touch on another key among the plurality of keys displayed on the input region 162 is generated prior to the elapse of the predetermined time in step 504.

Upon generation of a drag to the display region 161 from the input region 162 after the elapse of the predetermined time without generation of a touch on any key on the input region 162 during repetition of steps 504 and 505, then the controller 110 senses the generation in step 506, and searches in the e-mail template DB 131 of the memory 130 for templates whose titles sequentially include characters disposed on at least two keys touched during steps 504 and 505, and displays the found templates on the display region 161 in step 507.

Alternatively, upon generation of a drag to the display region 161 immediately after the generation of a touch on a particular key on the input region 162 during steps 504 and 505, then the controller 110 searches in the e-mail template DB 131 of the memory 130 for templates whose titles sequentially include characters disposed on at least two keys touched during repetition of steps 504 and 505 and displays the found templates on the display region 161 in step 507.

Thereafter, at least two templates displayed on the display region 161 may be displayed as images, and upon user's selection of one of them, the controller 110 senses the selection in step 508 and displays only the selected template in step 509.

The keys touched on the input region 162 in steps 502 and 504 may be identical or different keys. For example, if, in the e-mail creation mode, a touch is generated on the predetermined key on which the character “ [symbol] ” is disposed among the plurality of keys displayed on the input region 162, a touch is generated on the predetermined key on which the character “ [symbol] ” is disposed among the plurality of keys displayed on the input region 162, and then a drag to the display region 161 is generated, the controller 110 searches in the e-mail template DB 131 of the memory 130 for templates whose titles sequentially include the character “ [symbol] ” and the character “ [symbol] ”, e.g., the templates “ [symbol] 1(attendance/absence 1)”, “ [symbol] 2(attendance/absence 2)”, and “ [symbol] 3(attendance/absence 3)”. The controller 110 may display the templates “ [symbol] 1(attendance/absence 1)”, “ [symbol] 2(attendance/absence 2)”, and “ [symbol] 3(attendance/absence 3)” found in the e-mail template DB 131 as images on the display region 161.

FIG. 6 is a flowchart of a process of displaying a template during the e-mail creation mode of the portable terminal according to a fifth embodiment of the present invention.

Referring to FIGS. 1 and 6, upon selection of e-mail creation in the e-mail mode of the portable terminal, the controller 110 senses the selection and switches to the e-mail creation mode in step 601.

In the e-mail creation mode, the display unit 160 is displayed showing the display region 161 and the input unit 162; the display region 161 displays e-mail related contents according to an input on the input region 162; and the input region 162 displays the plurality of keys for a touch input.

During the e-mail creation mode, if at least one characters together with a special character are input and displayed in a title input box or a contents input box displayed on the display region 161 through the input region 162 of the display unit (160) or the key input unit 127, then the controller 110 senses the input and display in step 602, and searches in the e-mail template DB 131 of the memory 130 for templates whose titles sequentially include the input at least one characters and displays the found templates as images on the display region 161 in step 603.

During a display of the at least one templates as images in step 503, upon user's selection of one of them, the controller 110 senses the selection in step 604 and displays only the selected template in step 605.

For example, upon input of “* [symbol] ” or “ [symbol] *” in the title input box of the display region 161 during the e-mail creation mode, the controller 110 senses the input and searches in the e-mail template DB 131 of the memory 130 for the templates whose titles include the character “ [symbol] ” as its first character, e.g., the templates “ [symbol] (contract)”, “ [symbol] 1(attendance/absence 1)”, “ [symbol] 2(attendance/absence 2)”, and “ [symbol] 3(attendance/absence 3)”, and displays the found templates as images on the display region 161.

Alternatively, upon input of “* [symbol] ” or “ [symbol] *” in the title input box of the display region 161 during the e-mail creation mode, then controller 110 senses the input and searches in the e-mail template DB 131 of the memory 130 for the templates whose titles include “ [symbol] ”, e.g., the templates “ [symbol] 1(attendance/absence 1)”, “ [symbol] 2(attendance/absence 2)”, and “ [symbol] 3(attendance/absence 3)”, and displays the found templates as images on the display region 161.

During a display of the found templates, a character together with a special character may be input in the title input box of the display region 161 to search for a template whose title includes the input character among the displayed templates and display the found template.

During a display of the found templates, as shown in FIG. 2, a drag to the display region (161) may be generated after the generation of a touch on a predetermined key among the plurality of keys displayed on the input region 162 to search for a template whose title includes a character disposed on the touched key among the displayed templates and display the found template.

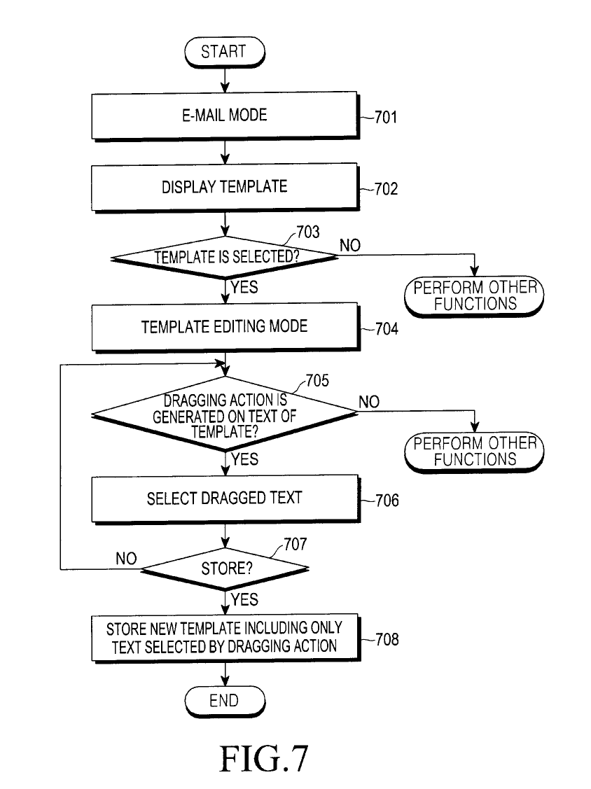

Next, with reference to FIGS. 7 through 10, a detailed description will be made of an operation of editing a template in the portable terminal.

FIG. 7 is a flowchart of a process of editing a template in the e-mail creation mode of the portable terminal according another embodiment of the present invention.

Referring to FIGS. 1 and 7, in step 701 which is the e-mail mode including the e-mail creation mode for e-mail creation or an e-mail reception mode for viewing a received e-mail, a template found in the e-mail template DB 131 of the memory 130 through FIGS. 2 through 5 is displayed or a template included in the received e-mail is displayed in step 702, and upon selection of editing, the controller 110 senses the selection in step 703 and switches to the template editing mode in step 704.

Upon generation of a drag on a predetermined text of the template displayed on the display unit 160 during the template editing mode, the controller 110 senses the generation in step 705 and selects the dragged text in step 706.

In step 706, the controller 110 may further select the selected text in word units or word spacing units through the dragging action.

Upon selection of storing during selection of the text through the dragging action, the controller 110 senses the selection in step 707, and displays and stores a new template including only the text selected by the dragging action in the text of the template in step 708.

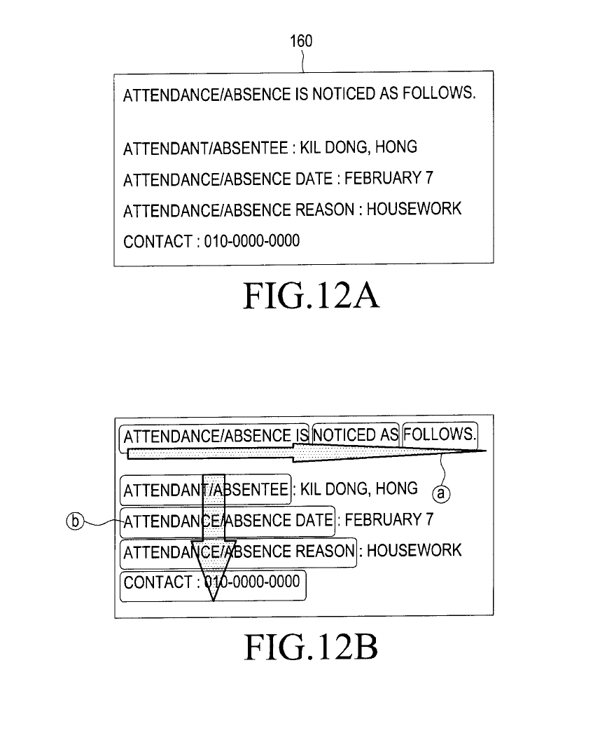

Referring to FIGS. 12A and 12B as an example to describe the process of FIG. 7, during a display of a template on the display unit 160 as shown in FIG. 12A, upon generation of a drag in a direction (a) and a drag in a direction (b) as shown in FIG. 12B, the controller 110 selects a text on which the drag in the direction (a) is generated (“Attendance/Absence is Noticed as Follows”), in word spacing units, and selects a text on which the drag in the direction (b) is generated (“Attendant/Absentee”, “Attendance/Absence Date”, “Attendance/Absence Reason”, and “Contact”) in word units, and then upon user's selection of storing, the controller 110 stores a new template including only the text on which the drag in the direction (a) is generated and the text on which the drag in the direction (b) is generated.

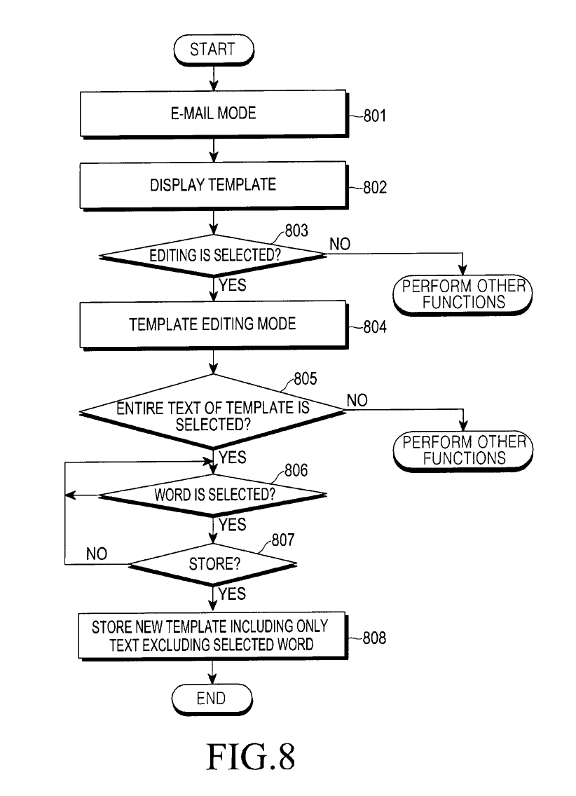

FIG. 8 is a flowchart of a process of editing a template in the e-mail creation mode of the portable terminal according to yet another embodiment of the present invention.

Referring to FIGS. 1 and 8, in step 801 which is the e-mail mode including the e-mail creation mode for e-mail creation or an e-mail reception mode for viewing a received e-mail, a template found in the e-mail template DB 131 of the memory 130 through FIGS. 2 through 6 is displayed or a template included in the received e-mail is displayed in step 802, and upon selection of editing, the controller 110 senses the selection in step 803 and switches to the template editing mode in step 804.

Upon generation of ‘select all’ with respect to the text of the template displayed on the display unit 160 in the template editing mode, the controller 110 senses generation and selects the entire text of the template in step 805. The selection of the entire text of the template may be performed by a particular menu function or a dragging action. After selection of the entire text of the template, if ‘release selection’ with respect to at least one words in the selected text is generated, the controller 110 senses the generation in step 806 and determines the selection-released at least one words in the entire text of the template or a phrase including the at least one words in step 806. ‘Release selection’ may be performed by a touch or drag on a corresponding word.

Thereafter, upon user's selection of storing, the controller 110 senses the selection in step 807, and displays and stores a new template including only the text excluding the selection-released at least one words or a phrase including the selection-released at least one words in step 808.

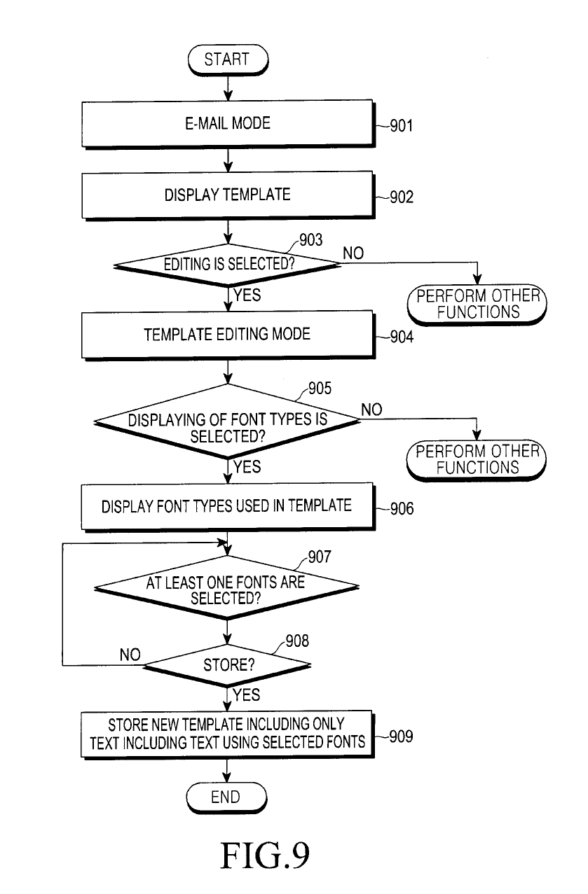

FIG. 9 is a flowchart of a process of editing a template during the e-mail mode of the portable terminal according to yet another embodiment of the present invention.

Referring to FIGS. 1 and 9, in step 901 which is the e-mail mode including the e-mail creation mode for e-mail creation or an e-mail reception mode for viewing a received e-mail, a template found in the e-mail template DB 131 of the memory 130 through FIGS. 2 through 6 is displayed or a template included in the received e-mail is displayed in step 902, and upon selection of editing, the controller 110 senses the selection in step 903 and switches to the template editing mode in step 904.

During a display of the template on the display unit 160 during the template editing mode, upon selection of ‘display font type’, the controller 110 senses the selection in step 905 and displays font types used in the template in step 906. The font types displayed in the step 906 are distinguished by corresponding colors and, also in the text of the template, each font type is displayed in a corresponding color thereof, such that the font types used in the template can be easily distinguished.

During a display of the font types, upon user's selection of at least one fonts, the controller 110 senses the selection in step 907 and determines a text using the selected at least one fonts. Upon user's selection of storing, the controller 110 senses the selection in step 908 and displays and stores a new template including only the text using the selected at least one fonts in step 909.

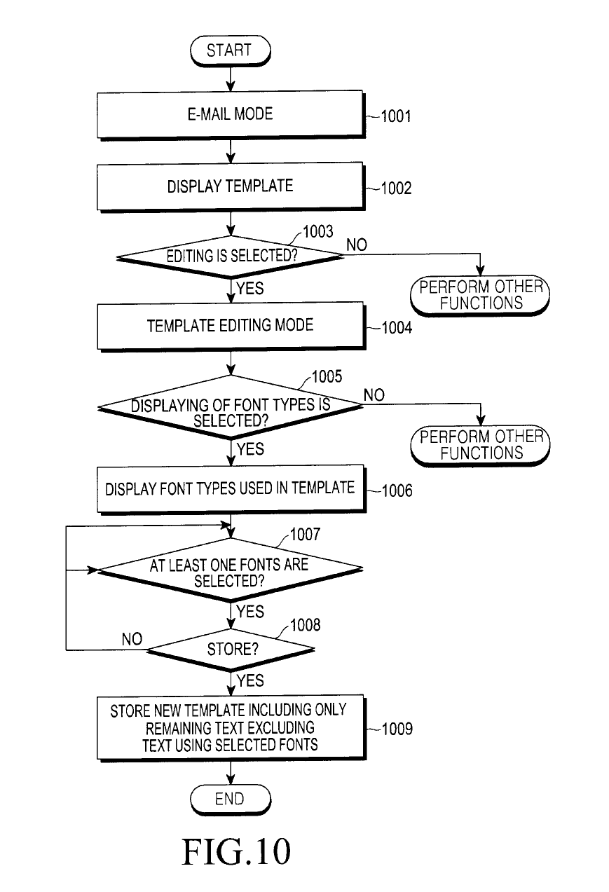

FIG. 10 is a flowchart of a process of editing a template in the e-mail creation mode of the portable terminal according to yet another embodiment of the present invention.

Referring to FIGS. 1 and 10, in step 1001 which is the e-mail mode including the e-mail creation mode for e-mail creation or an e-mail reception mode for viewing a received e-mail, a template found in the e-mail template DB 131 of the memory 130 through FIGS. 2 through 6 is displayed or a template included in the received e-mail is displayed in step 1002, and upon selection of editing, the controller 110 senses the selection in step 1003 and switches to the template editing mode in step 1004.

During a display of the template on the display unit 160 in the template editing mode, upon selection of ‘display font type’, the controller 110 senses the selection in step 1005 and displays font types used in the template in step 1006. The font types displayed in step 1006 are distinguished by corresponding colors and, also in the text of the template, each font type is displayed in a corresponding color, such that the font types used in the template can be easily distinguished.

During a display of the font types, upon user's selection of at least one font types, the controller 110 senses the selection in step 1007 and determines a text using the selected at least one font types. Upon user's selection of storing, the controller 110 senses the selection in step 1008 and displays and stores a new template including only the remaining text excluding the text using the selected at least one font types in step 1009.

As is apparent from the foregoing description, by providing an apparatus and method for creating an e-mail in the portable terminal, the e-mail can be conveniently created by using a template.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While detailed embodiments of the present invention, such as a portable terminal, have been described, various modifications can be carried out without departing from the scope of the present invention. Therefore, the scope of the invention is not defined by the foregoing embodiment of the invention, but should be defined by claims and equivalents thereof.

What is claimed is:

1. An apparatus for creating an e-mail in a portable terminal, comprising:
a display unit including an input region and a display region; and
a controller for displaying at least one template corresponding to a search gesture generated on the display unit, the search gesture including a touch input on a predetermined key of the input region and a subsequent drag of the predetermined key in the display region.

2. The apparatus of claim 1, wherein the controller displays the at least one template whose titles comprise a character corresponding to the predetermined key,
wherein the controller displays the at least one template whose titles comprise a character corresponding to the predetermined key as its first character.

3. The apparatus of claim 1, wherein if the search gesture is generated at least two times on the predetermined key within a predetermined time, the controller displays the at least one template whose titles sequentially include characters corresponding to the predetermined key.

4. The apparatus of claim 1, wherein the controller displays the at least one template whose titles comprise a character corresponding to the predetermined key, and
upon generation of another search gesture including a touch input on another key and a subsequent drag to the display region, the controller displays another template whose title comprises a character corresponding to the another key among the at least one template displayed on the display unit,
wherein the controller searches for the at least one first template whose titles comprise the character corresponding to the predetermined key as its first character and then searches for the at least one second template whose title comprises the character corresponding to the another key as the next character among the at least one first template for a display.

5. The apparatus of claim 1, wherein upon generation of the search gesture including touch inputs on at least two keys and a subsequent drag to the display region, the controller and displays a plurality of templates whose titles sequentially comprise characters corresponding to the touched at least two keys.

6. The apparatus of claim 1, wherein upon input of at least one character together with a special character, the controller displays a plurality of templates whose titles comprise the at least one character input together with the special character,
wherein the controller displays the plurality of templates whose titles sequentially comprise the at least one character input together with the special character.

7. The apparatus of claim 1, further comprising:
a memory for storing a plurality of templates,
wherein the controller for storing a new template comprising only a text selected in a template displayed during an e-mail mode.

8. The apparatus of claim 7, wherein the controller switches to a template editing mode in response to an editing request during the e-mail mode, and stores the new template comprising only a text of the template selected by a dragging action during the template editing mode,
wherein the controller selects the dragged text in word units or word spacing units.

9. The apparatus of claim 7, wherein the controller switches to the template editing mode in response to an editing request during the e-mail mode and upon release of selection of at least one word after selection of the entire text of in a particular template during the template editing mode, the controller stores the new template comprising only a text excluding the selection-released at least one word,
wherein the controller selects the entire text of the template in word units or word spacing units, and upon generation of touches on at least one word of the selected entire text, the controller releases selection with respect to the at least one word or a phrase comprising the at least one word.

10. The apparatus of claim 7, wherein the controller switches to a template editing mode in response to an editing request during the e-mail mode, displays font types used in a particular template during the template editing mode, and stores the new template comprising only a text using a selected font,
wherein the controller switches to a template editing mode in response to an editing request during the e-mail mode, displays font types used in a particular template during the template editing mode, and stores the new template comprising only the remaining text excluding a text using a selected font

11. A method for creating an e-mail in a portable terminal, the method comprising:
determining whether a search gesture including at least one of a character and a symbol or both is generated on a display unit during an e-mail creation mode; and
if the search gesture is generated on the display unit, displaying at least one template containing the generated search gesture.

12. The method of claim 11, wherein the displaying comprises:
upon generation of the search gesture including a touch input on a predetermined key and a subsequent drag to a display region of the display unit, displaying the at least one template whose titles comprise a character corresponding to the predetermined key,
wherein the at least one template whose titles comprise a character corresponding to the predetermined key as its first character.

13. The method of claim 11, wherein the displaying comprises:
a first step in which the search gesture including a touch input on a predetermined key on an input region of the display unit and a subsequent drag to a display region of the display unit is generated;
a second step of determining whether the search gesture is generated with respect to another key within a predetermined time after generation of the drag;
a third step of executing the second step if the search gesture is generated with respect to the another key within the predetermined time; and
a fourth step of displaying templates whose titles sequentially include characters disposed on the touched at least two keys, unless the search gesture is generated with respect to the another key within the predetermined time.

14. The method of claim 11, wherein the displaying comprises:
upon generation of the search gesture including a touch input on a predetermined key and a subsequent drag to a display region of the display unit during the e-mail creation mode, displaying first templates whose titles comprise a character corresponding to the predetermined key; and
upon generation of the search gesture comprising a touch on another key and a subsequent drag to the display region while displaying of the first templates, searching for at least one second template whose title comprises a character corresponding to the another key among the first templates displayed on the display unit,
wherein the first templates whose titles comprise the character corresponding to the predetermined key as its first character and then the at least one second template whose title comprises the character corresponding to the another key as the next character among the first templates.

15. The method of claim 11, wherein the displaying comprises:
determining whether the search gesture comprising touch inputs on at least two keys and a subsequent drag to the display region is generated during the e-mail creation mode within a predetermined time; and
if the search gesture is generated, displaying the at least one template whose titles sequentially comprise characters corresponding to the touched two keys.

16. The method of claim 1, wherein the displaying comprises:
upon input of at least one characters together with a special character on the display region of the display unit during the e-mail creation mode, displaying the at least one template whose titles comprise the at least one characters input together with the special character,
wherein the at least one template whose titles sequentially comprise the at least one characters input together with the special character are displayed.

17. The method of claim 11, further comprising:
displaying a template during an e-mail mode; and
storing a new template comprising only a text selected in the displayed template.

18. The method of claim 17, wherein the storing comprises:
upon selection of an editing request during a display of the template during the e-mail mode, switching to a template editing mode; and
upon generation of a dragging action on the template during the template editing mode, storing the new template comprising only a text selected by the dragging action from a text of the template,
wherein the dragged text is selected in word units or word spacing units.

19. The method of claim 17, wherein the storing comprises:
upon selection of an editing request during a display of the template during the e-mail mode, switching to the template editing mode; and
upon release of selection of at least one words after selection of the entire text of the template during the template editing mode, storing the new template comprising only a text excluding the selection-released at least one words,
wherein the releasing of the selection comprises:
selecting the entire text of the template in word units or word spacing units; and
upon generation of touches on at least one words of the selected entire text, releasing selection with respect to the at least one words or a phrase comprising the at least one words.

20. The method of claim 17, wherein the storing comprises:
switching to a template editing mode upon selection of an editing request during a display of the template during the e-mail mode;
displaying font types used in the template during the template editing mode; and
storing the new template comprising only a text using a selected font if the font is selected from among the displayed font types,
wherein the storing comprises:
switching to a template editing mode upon selection of an editing request during a display of the template during the e-mail mode;
displaying font types used in the template during the template editing mode; and
storing the new template comprising only the remaining text excluding a text using a selected font if the font is selected from among the displayed font types.
